(19) United States
(12) Patent Application Publication
(10) Pub. No.: US 2025/0041852 A1
(43) Pub. Date: Feb. 6, 2025

(54) ELECTROWETTING-ON-DIELECTRIC (EWOD) SYSTEM WITH MULTIPORT CONNECTION DESIGN

(71) Applicant: CYTESI, INC., Menlo Park, CA (US)

(72) Inventors: Tung-Yu WU, Menlo Park, CA (US); Tsung-Yuan WU, Menlo Park, CA (US); Jun-Chao LU, Menlo Park, CA (US)

(21) Appl. No.: 18/793,524

(22) Filed: Aug. 2, 2024

Related U.S. Application Data
(60) Provisional application No. 63/530,396, filed on Aug. 2, 2023.
(60) Provisional application No. 63/530,410, filed on Aug. 2, 2023.
(60) Provisional application No. 63/645,440, filed on May 10, 2024.

(51) Int. Cl. B01L 3/00

(52) U.S. Cl. CPC B01L 3/502715; B01L 3/502746; B01L 2300/0627

(57) ABSTRACT

Provided is a hydraulic multiport connection design for a microfluidic device. The electrowetting on dielectric (EWOD) system comprises a first connection device including a first housing, a first port, a second port, and a first channel within the first housing, the first channel coupling to the first port and the second port. A second connection device is coupled to the first connection device. The second connection device includes a second housing, a third port, a fourth port and a second channel within the second housing, the second channel coupling to the third port and the fourth port. The first connection device and the second connection device are coupled by securely engaging the second port to the third port. The second port and the third port are configured to be engaged seamlessly.

### CROSS-REFERENCE TO RELATED APPLICATIONS

This application claims the benefit and priority to the U.S. Provisional Patent Application No. 63/530,396 filed on Aug. 2, 2023, U.S. Provisional Patent Application No. 63/530,410 filed on Aug. 2, 2023, and the U.S. Provisional Patent Application No. 63/645,440 filed on 10 May 2024, the entirety of which is incorporated herein by reference.

### TECHNICAL FIELD

The present disclosure generally relates to a hydraulic multiport connection design. More particularly, the present disclosure relates to a hydraulic multiport connection design for a microfluidic device.

### BACKGROUND

Nowadays, the connectors for hydraulic system connections are single port design, which thus requires users to connect each transportation line via each single port for the whole system. However, the single port design may cause the following issues: (a) time consuming for the installation; (b) the cost for automating the connection process is high; (c) error-prone due to human installation, and (d) hard to miniaturize the system size

Additionally, the connectors for hydraulic system connections are used for an electrowetting device (EWOD), which is a well-known technique for manipulating droplets of fluid by application of an electric field. Specifically, microfluidics provide fluid management based on droplets. The droplets on the chip serve to transport a variety of reaction materials, including biochemical reagents, cells, proteins, DNA, and RNA. Microfluidics allow software-reconfigurable operations on individual droplets, such as movement, combination, splitting, and dispensation from reservoirs by manipulating Pico liter to Nano liter scale droplets in electric fields.

In recent years, more and more applications of digital microfluidics (DMF) apparatuses using EWOD have emerged. The DMF application has the ability to precisely manipulate and move small, discrete volumes of fluids.

To improve the connectors for hydraulic system connections with single port design, the present application aims to develop a novel system with multiple-port connections for fluid transportation.

### SUMMARY

Some embodiments of the present disclosure provide a system comprises a first connection device and a second connection device. The first connection device includes a first housing, a first port, a second port and a first channel. The first channel is arranged within the first housing, the first channel couples to the first port and the second port. The second connection device couples to the first connection device. The second connection device includes a second housing, a third port, a fourth port and a second channel. The second channel is arranged within the second housing. The second channel couples to the third port and the fourth port. The first connection device and the second connection device are coupled by securely engaging the second port to the third port. The second port and the third port are configured to be engaged seamlessly.

The first connection device and a second connection device form a microfluidic device. The invention may enhance procedures of scaling up the hydraulic connection system, and reduce installation errors. The design may facilitate automation of the connection process by allowing multiple ports to be connected at the same time. The special port connection design can provide large positioning tolerance.

### BRIEF DESCRIPTION OF THE DRAWINGS

The aspects of the present disclosure will become more easily understood from the following detailed description made with reference to the accompanying drawings. It should be noted that, various features may not be drawn to scale. In fact, the sizes of the various features may be increased or reduced arbitrarily for the purpose of clear description.

FIGS. 1A and 1B are schematic views of an EWOD system with multiport connection design; FIG. 1A shows the uncoupled state and FIG. 1B shows the coupled state according to some embodiments of the present disclosure;

FIGS. 1C-1F are schematic views of different configurations for an EWOD system according to some embodiments of the present disclosure;

FIG. 1G is a schematic view of an EWOD system with an array of multiport connections according to some embodiments of the present disclosure;

FIGS. 2A and 2B are schematic views of different configurations for an EWOD system according to some embodiments of the present disclosure;

FIG. 3A shows a schematic view of the multiport connection system with a single piece design according to some embodiments of the present disclosure;

FIG. 3B shows a schematic view of the multiport connection system with four separate pieces design according to some embodiments of the present disclosure;

FIGS. 4A-4C are schematic views of different configurations for a multiport connection system according to some embodiments of the present disclosure; and

FIG. 5A shows a schematic view of a part of the multiport connection system with the EWOD device with a single-core structure according to some embodiments of the present disclosure; FIG. 5B shows a schematic view of a part of the multiport connection system with the EWOD device with a double-core structure according to some embodiments of the present disclosure.

### DETAILED DESCRIPTION

The following disclosure provides many different embodiments, or examples, for implementing different features of the provided subject matter. Specific examples of components and arrangements are described below to explain certain aspects of the present disclosure. These are, of course, merely examples and are not intended to be limiting. For example, the formation of a first feature over or on a second feature in the description that follows may include embodiments in which the first and second features are formed or disposed in direct contact, and may also include embodiments in which additional features may be formed or disposed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only, and that practical implementations of the structures described herein can be spatially arranged in any orientation or manner, provided that the merits of embodiments of this disclosure are not deviated from by such arrangement.

It should be noted that the structures, proportions, sizes, etc. shown in the drawings of the specification are only used to match the content recorded in the specification for the understanding and reading of those skilled in the art, and are not used to limit the implementation of this application, so it has no technical substantive meaning. Any modification of structure, change of proportional relationship or adjustment of size, without affecting the effect and purpose of this application, should still fall within the scope of this application. The disclosed technical content must be within the scope covered. At the same time, terms such as “above”, “first”, “second” and “one” quoted in this specification are only for the convenience of description and are not used to limit the scope of implementation of this application. The change or adjustment of the relative relationship shall also be regarded as the implementable scope of the present application without substantive change in the technical content.

It should also be noted that the longitudinal section corresponding to the embodiments of the present application can correspond to the front view, the transverse section can correspond to the right view, and the horizontal section can correspond to the top view

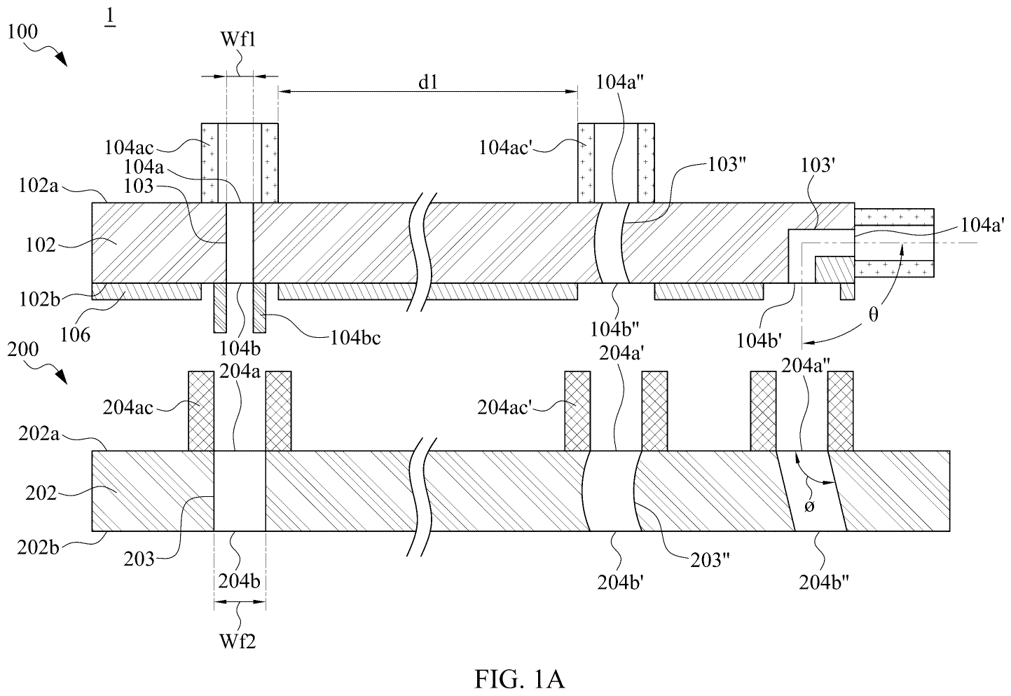

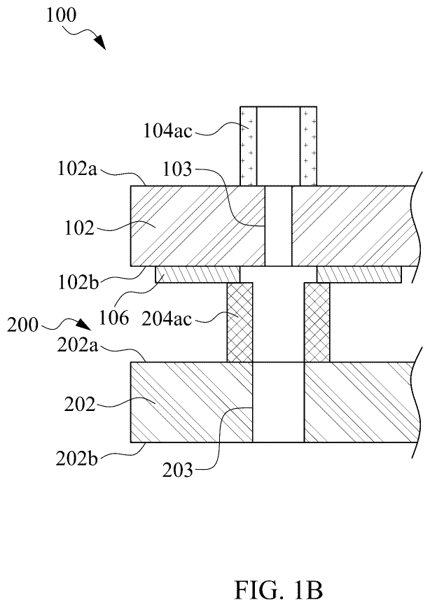

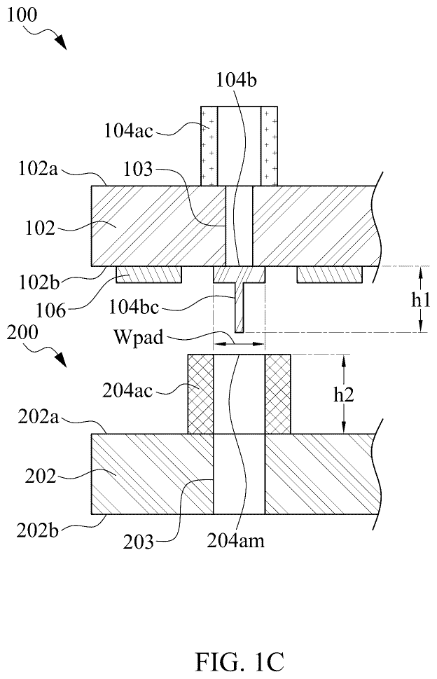

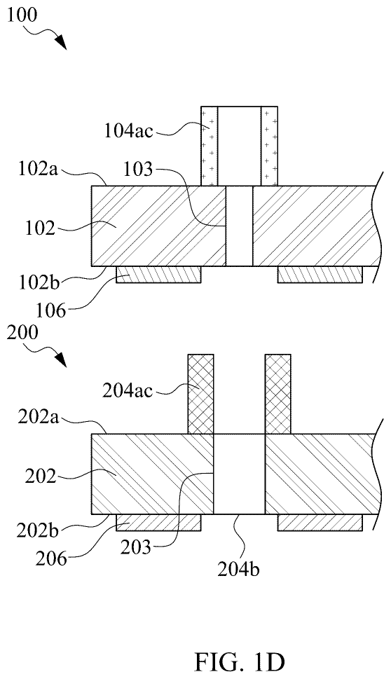

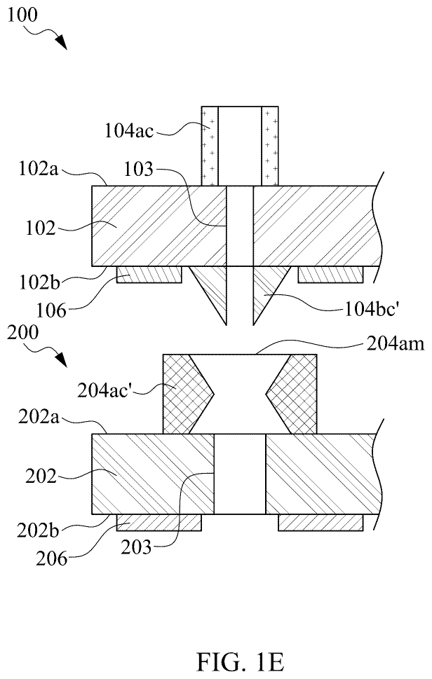

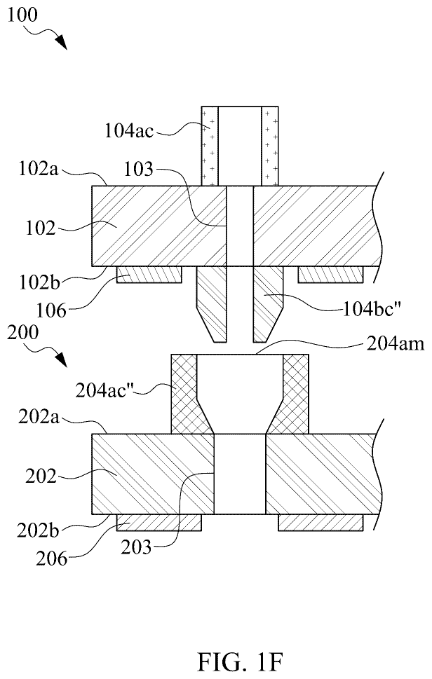

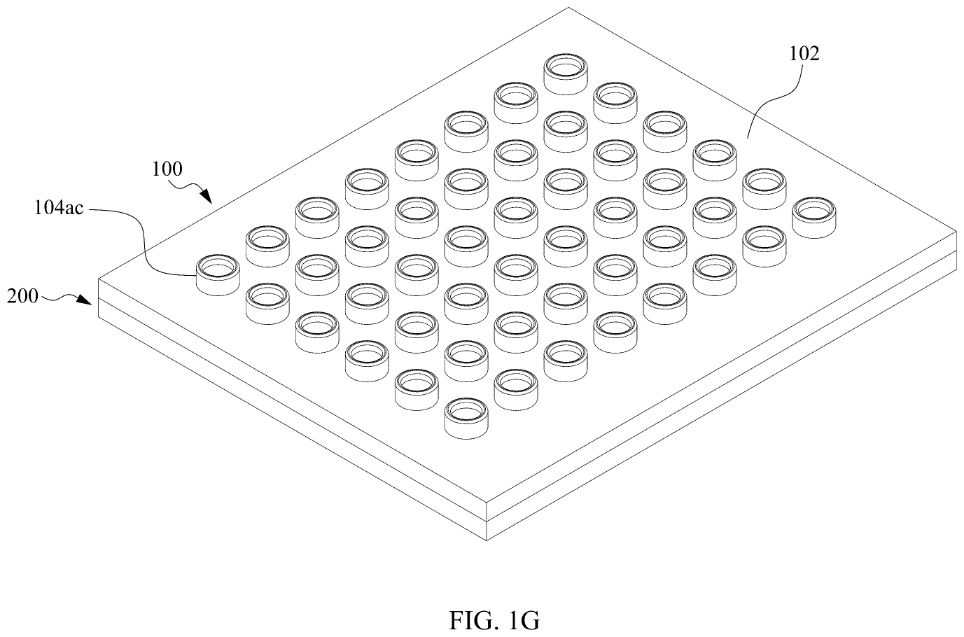

FIGS. 1A-1B are schematic views of a system with multiport connections; FIG. 1A shows the first connection device and the second device in an uncoupling state; and FIG. 1B shows the first connection device and the second device in a coupling state.

FIG. 1A shows an electrowetting on dielectric (EWOD) system 1. The EWOD system 1 includes a first connection device 100 and a second connection device 200. The second connection device 100 and the second connection device 200 are coupled to each other.

The first connection device 100 includes a first housing 102, a first port 104a, a second port 104b and a first channel 103. The first channel 103 is arranged within the first housing 102. The first port 104a couples to the second port 104b through the first channel 103. In some embodiments, the first port 104a is opposite to the second port 104b. The first channel 103 may be straight. In some embodiments, the first port 104a′ and the second port 104b′ may be positioned with an angle θ. The first channel 103″ may be curved. In some embodiment, the first connection device 100 may include more than one first ports 104a. The first connection device 100 may include more than one second ports 104b. One first port 104a may couple to a corresponding second port 104b. In some embodiments, more than one first ports 104a may connect to one second port 104b. In some embodiments, one first port 104a may couple to more than one second ports 104b.

The first channel 103 may be a manifold for one to many, many-to-one, or many to many configurations. In some embodiments, the first channel 103 may have one first port 104a at one end and have at least two second ports 104b at the other end. In some embodiments, the first channel 103 may have at least two first ports 104a at one end and one second port 104b at the other end. In some embodiments, the first channel 103 may have at least two first ports 104a at one end and have at least two second ports 104 at the other end.

The second connection device 200 includes a second housing 202, a third port 204a, a fourth port 204b and a second channel 203. The second channel 203 is arranged within the second housing 202. The third port 204a couples to the fourth port 204b through the second channel 203. In some embodiments, the third port 204a is opposite to the fourth port 204b. The second channel 203 may be straight. In some embodiments, the first channel 103″ may be curved. In some embodiment, the second connection device 200 may include more than one third ports 204a. The second connection device 200 may include more than one fourth ports 204b. One third port 204a may couple to a corresponding fourth port 204b. In some embodiments, more than one third ports 204a may connect to one fourth port 204b. In some embodiments, one third port 204a may couple to more than one fourth ports 204b.

In some embodiments, the third port 204a and the fourth port 204b may be positioned with an angle ϕ. In addition, the second channel 203 may be a manifold for one to many, many-to-one, or many to many configurations as the first channel 103.

The fourth port 204b may couple to an external device. The fourth port 204b may couple to a sensing device of EWOD system. In some embodiments, ports 204b, 204b′, and 204b″ may couple to the same sensing device. In some embodiments, ports 204b, 204b′, and 204b″ may couple to the same EWOD device. In some embodiments, ports 204b, 204b′, and 204b″ may couple to different sensing devices. In some embodiments, ports 204b, 204b′, and 204b″ may couple to different EWOD devices. The sensing device may be EWOD device including a top plate including at least one top electrodes, a bottom plate including at least one bottom electrodes and a fluid space between the top and bottom plates.

The first connection device 100 and the second connection device 200 are securely coupled to each other. The second port 104b of the first connection device 100 is mated to the third port 204a of the second connection device 200. The second port 104b of the first connection device 100 and the third port 204a of the second connection device 200 are designed to be engaged securely and seamlessly.

In some embodiments, the first port 104a of the first connection device 100 may include a first connector component 104ac. The first connector component 104ac may be attached to the first housing 102. In some embodiments, the first connector component 104ac may be integrated with the first housing 102. In some embodiments, the first connector component 104ac may be extruded from a surface 102a of the first connection device 100. In some embodiments, the first connector component 104ac′ may be embedded in the first connection device 100.

In some embodiments, the second port 104b of the first connection device 100 may include a second connector component. The second connector component may be attached to the first housing 102. In some embodiments, the second connector component may be integrated with the first housing 102.

In some embodiments, the third port 204a of the second connection device 200 may include a third connector component 204ac. The third connector component 204ac may be attached to the second housing 202. In some embodiments, the third connector component 204ac may be integrated with the second housing 202. In some embodiments, the third connector component 204ac may be extruded from a surface 202a of the second connection device 200. In some embodiments, the third connector component 204ac′ may be embedded in the second connection device 200.

In some embodiments, the fourth port 204b of the first connection device 200 may include a fourth connector component (not shown). The fourth connector component may be attached to the second housing 202. In some embodiments, the fourth connector component may be integrated with the second housing 202.

In some embodiments, the first port 104 may be couple to a hydraulic system (not shown). The port 104a may receive fluid. The fluid may include liquid. In some embodiments, the fluid may include oil. The fluid may be biologic samples. The fluid may include blood. The fluid may include DNA, RNA, genes, or the likes.

The first port 104a may be an opening on the first housing 102. The first port 104a connects the channel 103. In some embodiments, the first port 104a may include tubings, threaded fittings, Luer fittings (such as luer, mini luer, and etc.), or barbed fittings.

Similar to the first port 104a, each of the second port 104b, the third port 204a and/or the fourth port 204b may be an opening. In some embodiments, each of the second port 104b, the third port 204a and/or the fourth port 204b may include tubings, threaded fittings, Luer fittings (such as luer, mini luer, and etc.), or barbed fittings.

The first housing 102 may be a single layer structure or a multi-layer structure. The first housing 102 may be made of a single material or a combination of different materials. The first housing 102 may be made with at least one of the following materials: glass, polyetheretherketone (PEEK), polyphenylene sulfide (PPS), Polycarbonate (PC), Poly(methyl methacrylate) (Acrylic), Ultem, plastic, stainless steel, aluminum, fluoroelastomer, silicone rubber, EPDM, FFKM, TPU, TPE, TPA and/or nitrile butadiene rubber (NBR).

Similar to the first housing 102, the second housing 202 may be a single layer structure or a multi-layer structure. The second housing 102 may be made of a single material or a combination of different materials. The second housing 102 may be made with at least one of the following materials: glass, polyetheretherketone (PEEK), polyphenylene sulfide (PPS), Polycarbonate (PC), Poly(methyl methacrylate) (Acrylic), Ultem, plastic, stainless steel, and aluminum, fluoroelastomer, silicone rubber, EPDM, FFKM, TPU, TPE, TPA and/or nitrile butadiene rubber (NBR). In some embodiments, the material of the second housing 202 may be the same to that of the first housing 102. In some embodiments, the material of the second housing 202 may be different from that of the first housing 102.

In some embodiments, the first connection device 100 is made with hard materials (for example, stainless steel, aluminum) and the second connection device 200 is made with soft materials. The benefits of using soft materials is its simple manufacturing process, such as injection molding and hot pressing, which results in low cost. In addition, the second connection device 200, which incorporates soft materials, is capable of withstanding greater external forces and stresses, while also offering improved assembly tolerances. Furthermore, if the first connection device 100 and the second connection device 200 become tilted during use, a larger tolerance can offset the impact of the tilt between these two components.

In some embodiments, the first connection device 100 may include a set of first ports and a set of second ports. The set of first ports and the set of second ports may be formed to be a two-dimension (2D) array, a column, a pattern and/or a specific arrangement according to requirements. Referring to FIG. 1A, there is a distance d1 between the port 104a and the port 104a″.

Similar to the first connection device 100, the second connection device 200 may include a set of third ports and a set of fourth ports. The set of third ports and the set of fourth ports may be formed to be a 2D array, a column, a sequence and/or a specific arrangement according to requirements.

The set of second ports of the first connection device 100 correspond to the set of third ports of the second connection device 200. In some embodiments, the number of the second ports and third ports can be the same. In some embodiments, the number of the second ports and third ports can be different.

The first channel 103 has a width Wf1. The second channel 203 has a width Wf2. In some embodiments, the width Wf1 may be substantially the same to the width Wf2. In some embodiments, the width Wf1 may be different from the width Wf2. In some embodiments, the width Wf1 of the first channel 103 may be smaller than the width Wf2 of the second channel 203. The dimensions of Wf1 and Wf2 may range from 1 μm to 1 cm Preferably, The dimensions of Wf1 and Wf2 may range from 0.1 mm to 1 cm.

The EWOD system 1 may further includes a sealing component 106. The sealing component 106 may be arranged on a surface 102b of the first housing 102 surrounding the second port 104b. The sealing component 106 may form a flat panel on the surface 102b of the first housing 102 surrounding the second port 104b. In some embodiments, the sealing component 106 may be formed as a pad, wherein the pad may be soft. In some embodiments, the sealing component 106 may be formed with elastic material. In some embodiments, the sealing component 106 may be made as a single layer structure. In some embodiments, the sealing component 106 may be made as a multi-layer structure. The sealing component 106 may be made from resilient materials, such as fluoroelastomer, silicone rubber, EPDM, FFKM, TPU, TPE, TPA and/or nitrile butadiene rubber (NBR). The sealing component 106 may be composed of a single material or a combination of materials like glass, PEEK, PPS, plastic, stainless steel, aluminum, and etc.

In some embodiments, the first connection device 100 includes one or more the sealing components 106. In some embodiments, the second connection device 200 includes one or more sealing component (not shown). In some embodiments, both the first connection device 100 and the second connection device provide one or more sealing components. The sealing component 106 may be provided at least one of the first port 104a, the second port 104b, the third port 204a and the fourth port 204b. The sealing component 106 is provided to facilitate sealing port connection and increase error tolerance in manufacturing and mounting processes.

In some embodiments, the EWOD system 1 includes a plurality of sealing components 106. The sealing components 106 may be arranged to be a 2D array, a column, a sequence and/or a specific arrangement according to requirements. In some embodiments, the arrangement of the sealing components 106 corresponds to the arrangement of the second ports.

FIG. 1B shows the EWOD system 1 is in a coupling state. The first connection device 100 is coupled to the second connection device 200. The second port 104b of the first connection device 100 connects to the third port 204a of the second connection device 200. In some embodiments, the third connector component 204ac of the second connection device 200 connects to the second port 104b. In some embodiments, the third connector component 204ac of the second connection device 200 securely contacts the sealing component 106 attached to a surface 102b of the first connection device 100, wherein the sealing component 106 surrounds the second port 104b so that the second port 104b may connect to the third port 204a seamlessly. The sealing component 106 may provide sealing with a positioning tolerance between the second port 104b of the first connection device 100 and the third port 204a of the second connection device 200. A fluid may flow from the first channel 103 to the second channel 203 through the second port 104b and the third port 204a without leakage.

The ports 104a, 104b, 204a and 204b are designed for receiving/transporting fluid. The second port 104b of the first connection device 100 may be aligned and secured with the third port 204a of the second connection device 200. In some embodiments, the sealing component 106 surrounding the second port 104b may facilitate sealing the coupling between the second port 104b and the third port 204a. The coupling between the second port 104b of the first connection device 100 and the third port 204a of the second connection device 200 may be implemented by pressing, screwing, sticking, locking, and/or gravity.

FIG. 1B addresses the automated connections of the hydraulic multiport connection design, which simplifies the installation process, reduces costs, minimizes errors caused by manual installation, and facilitates downsizing of the hydraulic connection system to form a compact EWOD system. In addition, the EWOD system of the invention coupling with hydraulic connection can reduce difficulties of automating the connecting process by allowing multiple ports to be connected at the same time and providing large positioning tolerance. The traditional connection method utilizes a threaded device (such as luer fitting, barbed fitting) or an attachment device, and it only allows for one-to-one connection at one time. That is, the threaded device or the attachment device does not provide an array of ports or a series of ports that can connect multiple ports at once. The threaded device or the attachment device has a large spacing between ports since it may require larger space for manual operation. In contrast, the present invention allows for the connection of multiple ports at once and reduces the spacing between ports, making the overall system size more compact and reducing the complexity of the assembly process.

In some embodiments, each of the connector components 104ac, 204ac may be formed with of different materials, such as glass, PEEK, PPS, Polycarbonate (PC), Poly(methyl methacrylate) (Acrylic), Ultem, plastic, stainless steel, aluminum, fluoroelastomer, silicone rubber, EPDM, FFKM, TPU, TPE, TPA and/or nitrile butadiene rubber (NBR). In some embodiments, each of the connector components 104ac, 204ac may be flexible.

FIG. 1C shows another configuration with the second port 104b including a second port connector component 104bc. In some embodiments, the second port connector component 104bc may be shaped as a needle having a through-hole. In some embodiments, the second port connector component may be shaped as a cone having a through-hole. When coupling the first connection device 100 to the second connection device 200, the second port connector component 104bc may be inserted into the third connector component 204ac, and securely mounted to the third connector component 204ac. The second port connector component 104bc and the third connector component 204ac may be paired. The fluid may be flowing from the channel 103 through the through-hole of the port connector component 104bc and the third port 204 to the second channel 203.

In some embodiments, the length h1 of the second port connector component 104bc may be different from the length h2 of the third connector component 204ac. In some embodiments, the length h1 of the second port connector component 104bc may be substantially equal to the length h2 of the third connector component 204ac.

In some embodiments, the needle-shaped second port connector component 104bc may be embedded in the first connection device 100. In some embodiments, the needle-shaped second port connector component 104bc may be protruded from the surface 102b of the first connection device 100.

In some embodiments, the third connector component 204ac may include a membrane 204am. When coupling the first connection device 100 to the second connection device 200, the second port connector component 104bc may be inserted into the third connector component 204ac and puncture the membrane 204am.

In some embodiments, the needle-shaped second port connector component 104bc may be formed with flexible material, such as PEEK, PPS and/or plastic.

In some embodiments, the sealing element 106 may be provided on the surface 102b of the first connection device 100. Upon the needle-shaped second port connector component 104bc mounted to the third connector component 204ac, the sealing element 106 may surround the connector component 204ac and seal the connection between the second port connector component 104bc and the third connector component 204ac. The sealing element 106 may be formed with shrinkable material, such as heat shrinking material.

FIG. 1D shows another configuration that the second connection device 200 further include a sealing element 106 surrounding the fourth port 204b. The sealing component 206 may form a flat panel on the surface 202b of the second housing 202 surrounding the fourth port 204b. In some embodiments, the sealing component 206 may be formed as a pad, wherein the pad may be soft. In some embodiments, the sealing component 206 may be formed with elastic material. In some embodiments, the sealing component 206 may be formed with shrinkable material, such as heat-shrinking material. In some embodiments, the sealing component 206 may be made as a single layer structure. In some embodiments, the sealing component 206 may be made as a multi-layer structure. The sealing component 206 may be made from resilient materials, such as fluoroelastomer, silicone rubber, nitrile butadiene rubber (NBR). The sealing component 206 may be composed of a single material or a combination of materials like glass, PEEK, PPS, plastic, stainless steel, aluminum, and etc.

Corresponding to the arrangement of the fourth ports of the second connection device 200, the second connection device 200 may include a plurality of sealing components 206. The plurality of sealing components 206 may be arranged to be a 2D array, a column, a sequence and/or a specific arrangement according to requirements.

FIGS. 1E-1F show various configurations that EWOD system with different shaped ports.

As shown in FIG. 1E, the third connector component 204ac′ may be shaped as an hourglass. The hourglass-shaped third connector component 204ac′ have a narrow neck to control the flow rate of the fluid flowing from first channel 103 to the second channel 203.

Corresponding to the hourglass-shaped third connector component 204ac′, the second port 104b may have a funnel-shaped connection component 104bc′. The funnel-shaped connection component 104bc′ may be mated to the hourglass-shaped third connector component 204ac′.

In some embodiments, the third connector component 204ac′ may include a membrane 204am. The membrane may facilitate preventing leakage of fluid. The membrane 204am may be arranged at the opening at receiving terminal of the third connector component 204ac′. In some embodiments, the membrane 204am may be arranged at the neck of the hourglass-shaped third connector component 204ac.

Referring to FIG. 1F, the third connector component 204ac″ may be shaped to be a funnel. The funnel-shaped connector component 204ac″ includes a wide opening for receiving fluid, and a narrow opening for transmitting fluid. The narrow opening for transmitting fluid may facilitate controlling the flow rate of the fluid. The inner diameters along the through hole of the funnel-shaped connector component 204ac″ varies according to requirements. The inner wall of the of the funnel-shaped connector component 204ac″ is designed according to requirements. The inner wall of the of the funnel-shaped connector component 204ac″ may have a variety of slopes.

The third connector component 204ac″ may include a membrane 204am. The membrane 204am may be arranged at the opening at a receiving terminal of the funnel-shaped third connector component 204ac′.

In some embodiments, the shapes of the connector components may be symmetric or asymmetric.

In some embodiments, the EWOD system may include more than two connection devices. The second connection device may further couple to additional connection devices through ports.

FIG. 1G is a schematic view of an EWOD system with an array of multiport connections. As shown in FIG. 1G, the first connection device 100 shows a 6×8 array ports design. In some embodiments, the first connection device 100 can have a 3×4 array configuration or an 8×12 configuration based on situational needs. The second connection device 200 have the ports corresponding to the ones of the first connection device 100. In some embodiments, the first connection device 100 and the second connection device 200 have the same number of ports. In some embodiments, the first connection device 100 and the second connection device 200 have different number of ports.

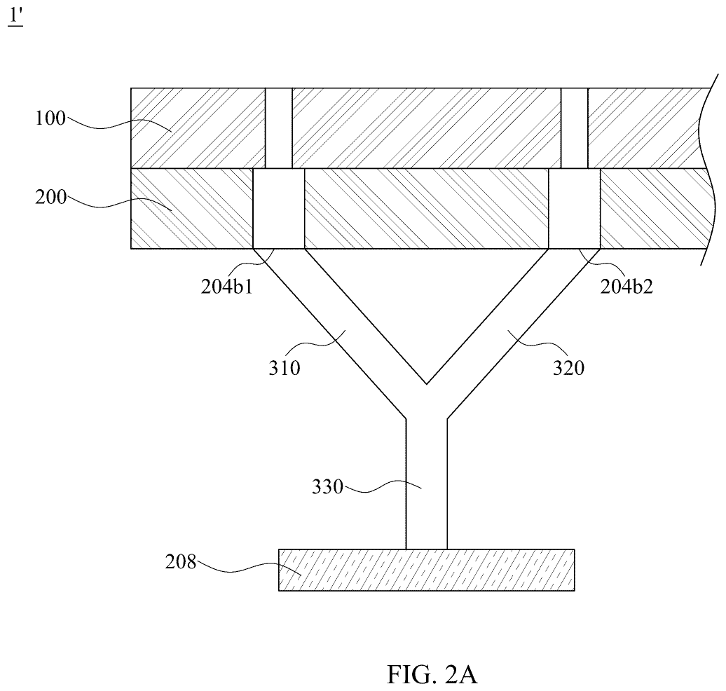

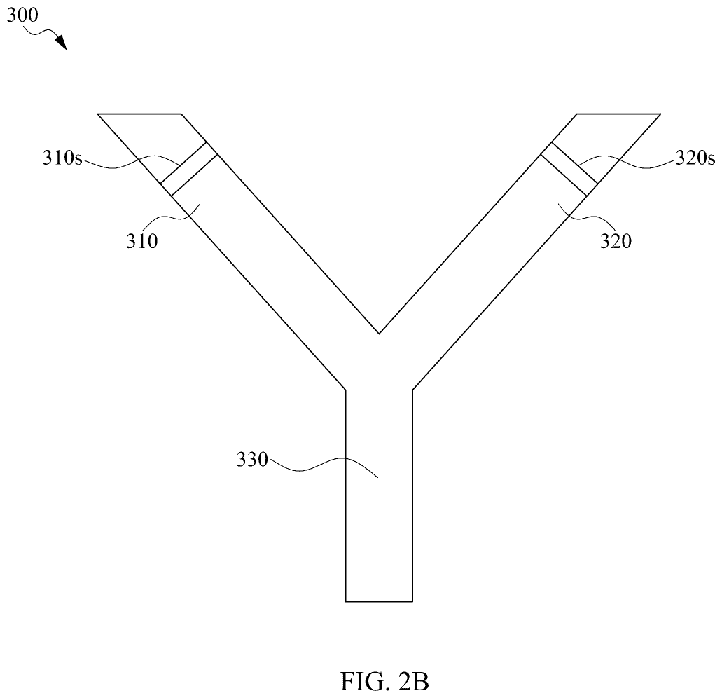

FIG. 2A illustrate another embodiment of EWOD system 1′. The EWOD system further includes a manifold device 300. FIG. 2A illustrates that the manifold device 300 is arranged between the second connection device 200 and a target device 208. FIG. 2B illustrate an enlarged figure of the manifold device 300 of FIG. 2A.

The manifold device 300 includes branches 310, 320 for receiving fluid and a branch 330 for transmitting fluid. The manifold device 300 may receive more than three branches, not limited to two branches for receiving fluid, and not limited to only one branch for transmitting fluid. The branch 310 may receive fluid from port 204b1 and the branch 320 may receive fluid from port 204b2, and the fluid from port 204b1 may be main fluid and the fluid from port 204b2 may be secondary fluid.

The branch 310 couples to one port 204b1 of the second connection device 200, and the branch 320 couples to one port 204b2 of the second connection device 200. The branch 310 may include a switch 310s. The branch 320 may include a switch 320s. The switch 310s and the switch 320s may be controllable together or individually. The branch 310 and the branch 320 may respectively couple to mass flow controllers (MFC). In some embodiments, the switch 310s and the switch 320s may respectively couple to the mass flow controllers (MFC). The fluid flow rate and flow amount through the branch 310 and through the branch 320 may be respectively controllable.

The switch 310s and the switch 320s may be opened at the same time. In some embodiments, the switch 310s and the switch 320s may be opened in turn. The open frequency of the switch 310s and the open frequency of the switch 320s may be different. In some embodiments, the open cycle of the switch 310s and the open cycle of the switch 320s may be overlapped.

In some embodiments, the manifold device 300 may be arranged at upstream of the target device 208. The manifold device 300 may couple to the target device 208. The branch 330 may transmit fluid from the branch 310 and from the branch 320 to the target device 208.

In some embodiments, the manifold device 300 may be arranged at upstream of EWOD system. The manifold device 300 may be arranged at upstream of the first connection device 100. The branches 310, 320 respectively receive fluid from different sources and then transmit the fluid to the first connection device 100.

In some embodiments, the manifold device 300 may be arranged between the first connection device 100 and the second connection device 200. The branches 310, 320 respectively receive fluid from different ports of the first connection device 100 and then transmitting to the second connection device 200.

In some embodiments, the manifold device 300 may be embedded in the first connection device 100 and/or the second connection device 200. The manifold device 300 can be Y-shaped, T-shaped, cross-shaped, col-flow, flow-focusing, etc.

In some embodiments, optional coating(s) can be applied to all or part of the systems to achieve specific functions, such as hydrophobicity, hydrophilicity, and etc. The coating can be applied to any tubes within the system. In some embodiments, optional coating(s) can be used for antifouling.

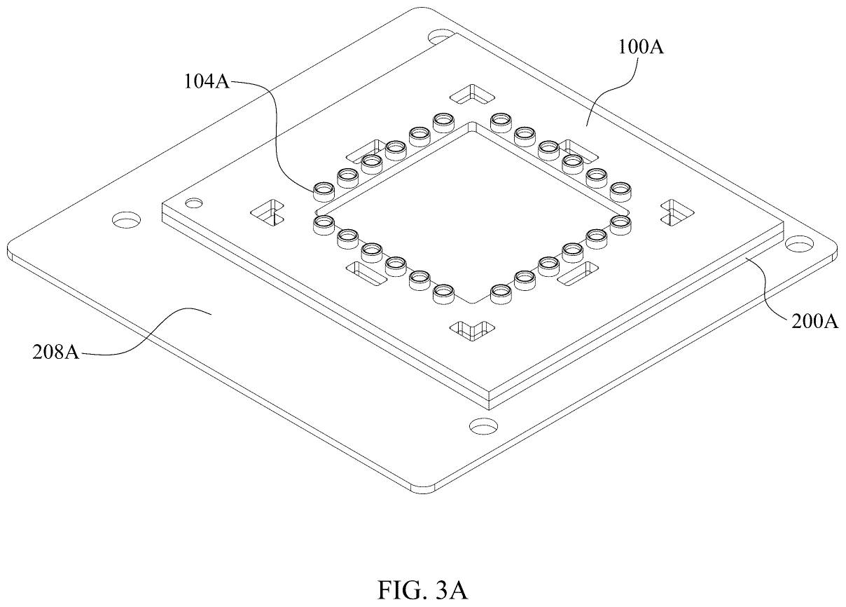

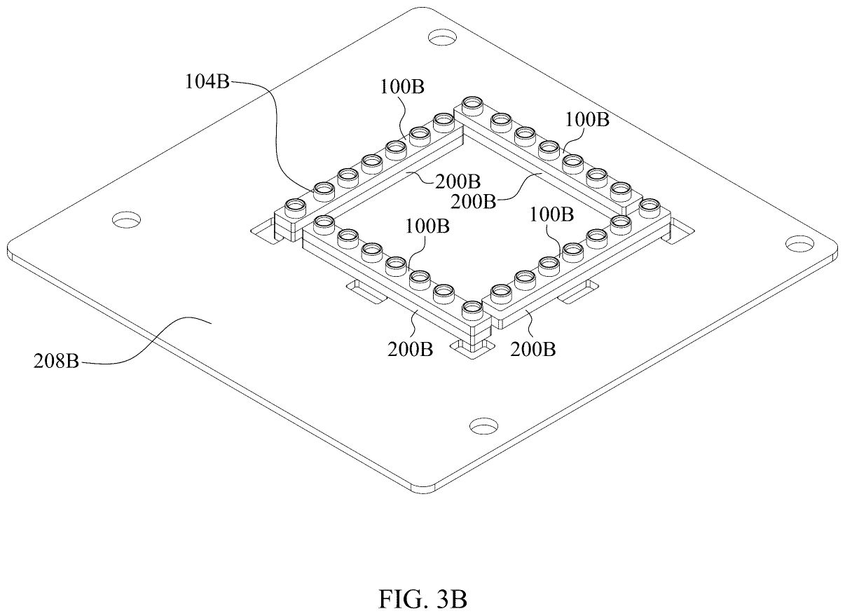

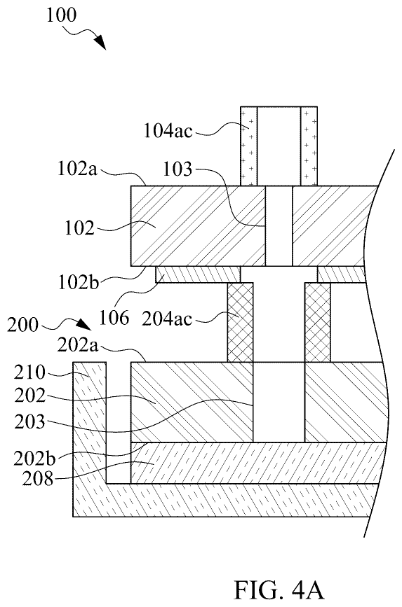

FIG. 3A shows a schematic view of the multiport connection system with a single piece design according to some embodiments of the present disclosure. FIG. 3B shows a schematic view of the multiport connection system with four separate pieces design according to some embodiments of the present disclosure. The subject invention does not limit to four separate pieces design. The invention may include multiple pieces.

As shown in FIG. 3A, the connection device 100A (may correspond to the structure 100 in FIGS. 1A-1F) could be formed as a single piece. The connection device 100A may include multiple ports. FIG. 3A shows the connection device 100A has a total of 24 ports 104A (may correspond to the ports 104a in FIGS. 1A-1F) arranged into a square. In some embodiments, the number of the ports 104A on each side of the square may be the same or be different. In some embodiments, the ports 104A may be arranged into different shape based on the design of the hydraulic system. The first connection device 100A couples to a second connection device 200A. The second connection device 200A may further couples to a target device 208A. In some embodiments, the target device 208A includes one or more sensing device for sensing the fluid.

In some embodiments, as shown in FIG. 3B, the first connection device 100B includes 4 pieces. FIG. 3B shows the first connection device 100B has a total of 28 ports 104B (may correspond to the features 104 in FIGS. 1A-1F) arranged into a square. In some embodiments, the number of the ports 104B on each side of the square may be the same or be different. In some embodiments, the ports 104B may be arranged into different shape based on the design of the hydraulic system. The first connection device 100B couples to a second connection device 200B. The second connection device 200B may further couple to a target device 208B. In some embodiments, the target device 208B includes one or more sensing device for sensing the fluid.

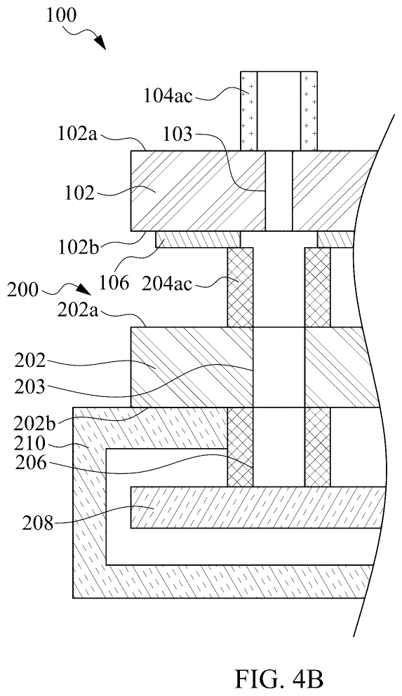

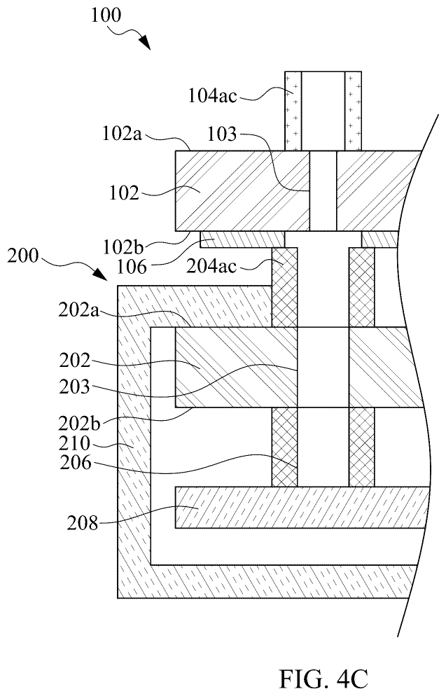

FIGS. 4A-4C are schematic views of different configurations for a multiport connection system according to some embodiments of the present disclosure.

FIG. 4A shows a target device 208 may couple to the second connection device 200. The target device 208 may include a sensing device for sensing the fluid. The target device 208 may contact and couple to the second connection device 200. In some embodiments, the frame 210 may be provided to protect for the target device 208. The frame 210 may receive the target device 208. In some embodiment, the frame 210 encapsulates the target device 208.

FIG. 4B shows another embodiment of the present invention. A wall of the frame 210 may be arranged between the coupled connection devices 100, 200 and the target device 208. The frame 210 (including the target 208 or free of the target 208) and the connection device 200 may be decoupled with the connection device 100. In some embodiments, the frame 210 may be attached to the second connection device 200. The target device 208 may be suspended in the space surrounded by the frame 210.

FIG. 4C shows another embodiment of the present invention. A wall of the frame 210 may be arranged between the first connection device 100 and the second connection device 200. In some embodiments, the frame 210 may be attached to the first connection device 100 and/or the second connection device 200. The frame 210 (including the target 208 or free of the target 208) and the connection device 200 may be decoupled with the connection device 100. The target device 208 may be suspended in the space formed by the connection device 200 and the frame 210.

In some embodiments, the second connection device 210 is made of soft/flexible materials. The soft/flexible materials (i.e., the second connection device 210) of the second connection device may suffer stress between the connection devices 100, 200 and the target device 108. The target device may include glass panels. The connection device with flexible material may prevent damage or rupture of the target device.

In some embodiments, the second connection device 200 is coupled to the target device 208 and the first connection device 100 is coupled to a control system (not shown). When the target device 208 needs to be replaced, one only needs to remove the coupled second connection device 200 and the target device 208 without moving the first connection device 100 and the control system, which can reduce the complexity of the assembly process.

The advantages of the suspension of target device 208 may reduce direct force on the target device (for example, a chip) and thus it can reduce deformation of the target device 208 and thus lower the risk of breaking the target device 208. FIG. 4A provides an easier design for a multiport connection system compared to the ones shown in FIGS. 4B and 4C. FIGS. 4B and 4C provides different suspension designs for a multiport connection system for lowering the forces/stresses caused by the contact between different components/materials.

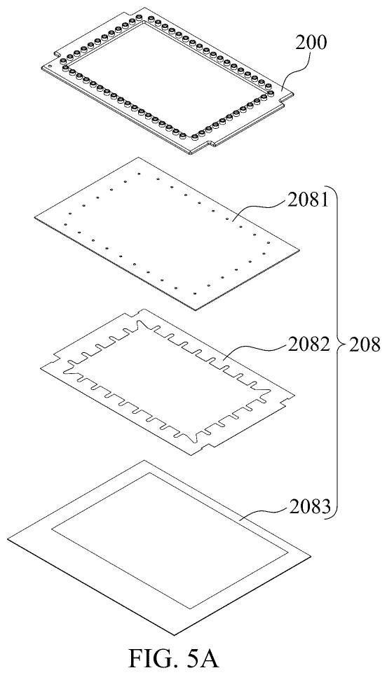

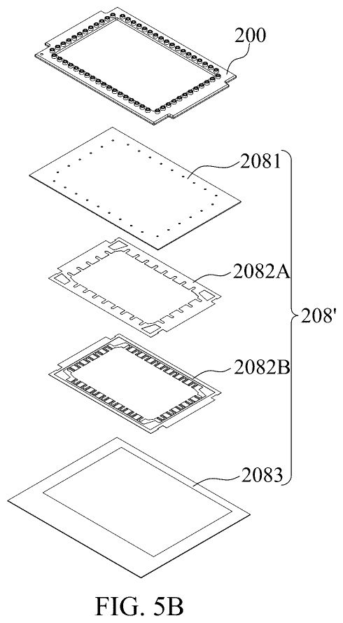

FIG. 5A shows a schematic view of a part of the multiport connection system with the EWOD device with a single-core structure according to some embodiments of the present disclosure; FIG. 5B shows a schematic view of a part of the multiport connection system with the EWOD device with a double-core structure according to some embodiments of the present disclosure.

FIG. 5A shows the second connection device 200 coupling to the target device 208. The target device 208 can be an EWOD device with an upper plate 2081 including at least one electrodes, a core-spacer 2082, and a bottom plate 2083 including at least one bottom electrodes. The core-spacer 2082 is arranged between the upper plate 2081 and the bottom plate 2083. The upper and bottom plates 2081, 2083 and the core-spacer 2082 provide a fluid space. The fluid space may receive droplet(s) and the surrounding medium around the droplet(s). The core-spacer 2082 provides a distance between the upper plate 2081 and the bottom plate 2083.

As shows in FIG. 5A, the core-spacer 5082 shows a comb-like pattern. The comb-like patterned core-spacer provides channels to confine the fluid including the droplets and/or the surrounding medium by the wall of the comb-like pattern. Each channel of the comb-like patterned core-spacer may correspond to one or more ports of the target device 208 connecting to port of the second connections device. The core-spacer 2082 may provide a distance between the upper plate 2081 and the bottom plate 2083 remains substantially unchanged when external forced is applied to the EWOD device. In some embodiments, the core-spacer 2082 has a thickness ranging from 10 μm to 1 mm. In some embodiment, the core-spacer 2082 is made of flexible material. The core-spacer 2082 may absorb the stress between the upper plate 2081 and the bottom plate 2083.

In some embodiments, the core-spacer 2082 may be a single-core structure.

In some embodiments, the connection between the core-spacer 2082 and the plates 2081, 2083 is through an adhesion, such as a glue. In some embodiments, the connection between the core-spacer 2082 and the upper plate 2081/the bottom plate 2083 is through the surface treatment (for example, by oxygen plasma).

In some embodiments, the material of the core-spacer 2082 may be made with at least one of the following materials: Polyimide (PI), PDMS, PEEK, PET, PC, PVC, ABS, PE, PP, BOPP, glass fiber, metal, plastic, ceramic, and etc.

In some embodiment, the EWOD device includes a multiple-core structure including more than one core-spacers. FIG. 5B shows the second connection device 200 coupling to the target device 208′ with a multiple-core structure. The target device 208′ may include a first core 2082A and a second core 2082B between an upper plate 2081 and a bottom plate 2083. The core-spacer 2082A and/or the core spacer 2082B may be formed with the same materials or different materials. In some embodiments, one of core-spacer 2082A and core-spacer 2082B provide rigid support between the upper plate 2081 and the bottom plate 2083, and the other one provide flexible support between the upper plate 2081 and the bottom plate 2083. The core-spacer 2082A and core-spacer 2082B may be connected with adhesion, such as a glue.

The foregoing outlines features of several embodiments and detailed aspects of the present disclosure. The embodiments described in the present disclosure may be readily used as a basis for designing or modifying other processes and structures for carrying out the same or similar purposes and/or achieving the same or similar advantages of the embodiments introduced herein. Such equivalent constructions do not depart from the spirit and scope of the present disclosure, and various changes, substitutions, and alterations may be made without departing from the spirit and scope of the present disclosure.

What is claimed is:

1. An electrowetting on dielectric (EWOD) system (1), comprising:
a first connection device (100) comprising:
a first housing (102), a first port (104a), a second port (104b), and a first channel (103) within the first housing (102), the first channel coupling to the first port (104a) and the second port (104b); and
a second connection device (200) coupled to the first connection device (100), the second connection device (200) comprising:
a second housing (202), a third port (204a), a fourth port (204b) and a second channel (203) within the second housing (202), the second channel coupling to the third port (204) and the fourth port (204b);
wherein the first connection device (100) and the second connection device (200) are coupled by securely engaging the second port (104b) to the third port (204a).
wherein the second port (104b) and the third port (204a) are configured to be engaged seamlessly.

2. The EWOD system according to claim 1, wherein at least one of the first port, the second port, the third port and the fourth port comprises at least one of the following: tubings, threaded fittings, Luer fittings, and barbed fittings.

3. The EWOD system according to claim 1, further comprising a sealing element (106) surrounding the second port.

4. The EWOD system according to claim 3, wherein the sealing element is a single layer structure.

5. The EWOD system according to claim 1, further comprising a plurality of sealing elements, wherein the plurality of sealing elements are forms as pads.

6. The EWOD system according to claim 3, wherein the sealing element (106) is made from resilient materials, such as fluoroelastomer, silicone rubber, nitrile butadiene rubber (NBR), EPDM, FFKM, TPU, TPE, TPA.

7. The EWOD system according to claim 1, wherein the second port comprises a needle-shaped connector component.

8. The EWOD system according to claim 7, wherein the third port further comprises an hourglass-shaped connector component.

9. The EWOD system according to claim 7, wherein the third port further comprises a funnel-shaped connector component.

10. The EWOD system according to claim 1, wherein the first housing is made with at least one of the following materials: glass, polyetheretherketone (PEEK), polyphenylene sulfide (PPS), Polycarbonate (PC), Poly(methyl methacrylate) (Acrylic), Ultem, plastic, stainless steel, aluminum, fluoroelastomer, silicone rubber, EPDM, FFKM, TPU, TPE, TPA and/or nitrile butadiene rubber (NBR).

11. The EWOD system according to claim 1, wherein the third port (204a) of the second connection device further comprises a third connector component (204ac) provided with a membrane.

12. The EWOD system according to claim 1, further comprising a manifold device (300) coupled to the second connection device.

13. The EWOD system according to claim 12, wherein the manifold device (300) comprises multiple branches for receiving fluid.

14. The EWOD system according to claim 13, wherein at least one of the multiple branches comprises a switch for controlling the flow rate of the fluid.

15. The EWOD system according to claim 1, further comprising a sensing device for sensing the fluid.

16. The EWOD system according to claim 15, further comprising a frame enclosing the sensing device.

17. The EWOD system according to claim 15, further comprising a frame attached to the first connection device and/or the second connection device.

18. The EWOD system according to claim 15, wherein the sensing device including a core-spacer between an upper plate and a bottom plate.
